(19) United States
(12) Patent Application Publication
(10) Pub. No.: US 2002/0024223 A1
(43) Pub. Date: Feb. 28, 2002

(54) Slider for reducing friction and vibrations between a latch and a guide support of a slide lock

(76) Inventors: Remi Bolduc, St. Anselme (CA); Benoit Champoux, Rock-Forest (CA); Dominic Charpentier, St-Nicephore (CA); Ron Clark, Millersburg, OH (US); Pierre-Louis Foucault, St-Lambert (CA)

Correspondence Address: MERCHANT & GOULD PC, P.O. BOX 2903, MINNEAPOLIS, MN, 55402-0903, US

(21) Appl. No.: 09/746,707

(22) Filed: Dec. 22, 2000

(30) Foreign Application Priority Data
Dec. 24, 1999 (CA) 2,293,224

(51) Int. Cl. E05C 1/06

(52) U.S. Cl. 292/138

(57) ABSTRACT

A slider for use with a slide lock of the type having a guide support and a latch slidably movable through apertures of the guide support. The slider includes a main body having opposite first and second surfaces, and mounting hooks provided on the first surface of the main body for removably mounting the slider onto an aperture of the guide support of the slide lock. The slider further includes a channel extending inside the main body from the first surface to the second surface thereof, the channel being shaped and sized to allow the latch of the slide lock to freely slide therethrough. The channel is further devised to reduce friction and vibrations of the latch sliding through the channel of the slider. The thickness of the main body is devised so as to absorb the noise and vibrations caused by the impact from the end of travel of the sliding latch hitting against the guide support of the slide lock. The above-mentioned features of the slider enable to substantially prolong the service life of the slide lock.

### FIELD OF THE INVENTION

The present invention relates to a slide lock such as the ones used in the lock industry. More particularly, the present invention relates to a slider to be used with such a lock for reducing the noise, friction and vibrations between the latch and the guide support thereof, the present invention being primarily intended for slide locks used with either residential or commercial garage doors.

### BACKGROUND OF THE INVENTION

Cable-operated doors such as garage doors and the slide locks used therewith are very well known in the art. These slide locks typically comprise a sliding latch and a guide support for guiding the movement of the latch, generally by constricting the latch to slide through corresponding apertures of the guide support. A major problem associated with the above-mentioned locks is that they are subject to substantial noise, friction, and vibrations due to the sliding contact between the latch and the guide support thereof which are usually both made of metal. Therefore, it would be useful to provide a slider to be used with such type of lock which would enable to reduce the noise, friction, and vibrations between the latch and the guide support of the slide lock. It would also be useful to provide a slider which could easily be mounted onto such type of slide lock. Moreover, it would also be useful to provide a slider which could be inexpensively manufactured, thereby making the slider very cost-effective.

### SUMMARY OF THE INVENTION

The main objects of the present invention are to provide a slider which satisfies each of the above-mentioned needs.

More particularly, a first object of the invention is to provide a slider to be used with a slide lock which enables to reduce the noise, friction, and vibrations between the latch and the guide support of the slide lock.

A second object of the present invention is to provide a slider which can be easily mounted onto a slide lock.

A third object of the present invention is to provide a slider which can be inexpensively manufactured.

In accordance with the invention, the above objects are achieved by a slider for use with a slide lock of the type comprising a guide support and a latch slidably movable through apertures of the guide support, said slider comprising:

a main body having opposite first and second surfaces; and

mounting means provided on the first surface of the main body for removably mounting the slider onto an aperture of the guide support of the slide lock;

wherein the slider further comprises a channel extending inside the main body from the first surface to the second surface thereof, said channel being shaped and sized to allow the latch of the slide lock to freely slide therethrough.

Preferably, the channel is further devised to reduce friction and vibrations of the latch sliding through the channel of the slider. Preferably also, the thickness of the main body, that is, the distance between the opposite first and second surfaces, is devised so as to absorb the noise and vibrations caused by the impact from the end of travel of the sliding latch hitting against the guide support of the slide lock.

According to the present invention, there is also provided a slide lock of the type comprising a guide support and a latch slidably movable through apertures of the guide support, said slide lock further comprising a slider, said slider comprising:

a main body having opposite first and second surfaces; and

mounting means provided on the first surface of the main body for removably mounting the slider onto an aperture of the guide support of the slide lock;

wherein the slider further comprises a channel extending inside the main body from the first surface to the second surface thereof, said channel being shaped and sized to allow the latch of the slide lock to freely slide therethrough, said channel being further devised to reduce friction and vibrations of the latch sliding therethrough.

The invention and its advantages will be better understood by reading the following non-restrictive description of a preferred embodiment thereof, made with reference to the accompanying drawings.

### BRIEF DESCRIPTION OF THE DRAWINGS

FIG. 1 is a perspective view of the slider according to a preferred embodiment of the invention.

FIG. 2 is a front view of the slider shown in FIG. 1.

FIG. 3 is a cross-sectional view taken along line A-A of the slider shown in FIG. 2.

FIG. 4 is a cross-sectional view taken along line B-B of the slider shown in FIG. 2.

FIG. 5 is another perspective view of the slider shown in FIG. 1.

FIG. 6 is a front view of a slide lock including two of the sliders shown in FIG. 1, said sliders being shown respectively mounted onto corresponding apertures of the slide lock.

FIG. 7 is a rear view of the slide lock shown in FIG. 6.

FIG. 8 is a perspective front view of the slider shown in FIG. 1, said slider being shown mounted onto a corresponding aperture of a guide support of yet another slide lock.

FIG. 9 is an enlarged side view of one of the sliders shown in FIG. 7

FIG. 10 is an enlarged side view of the slider shown in FIG. 8.

### DETAILED DESCRIPTION OF A PREFERRED EMBODIMENT OF THE INVENTION

In the following description, the same numerical references refer to similar elements. Moreover, although the present invention was primarily designed for a slide lock to be used with a garage door, it could be used with other types of doors of different fields, e.g. house doors, compartment doors, etc., as apparent to a person skilled in the art. For this reason, expressions such as “cable-operated door” and/or “garage door” and any other references and/or other expressions equivalent thereto should not be taken as to limit the scope of the present invention and include all other objects with which the present invention could be used and may be useful.

Moreover, although the preferred embodiment of the present invention as shown and explained herein is of rectangular configuration, the expression “rectangular” and any other derivative thereof and/or implicit connotation thereto should not be taken in their restrictive sense and thus should not be taken as to limit the scope of the present invention. It is to be understood, as also apparent to a person skilled in the art, that the slider according to the present invention may take on various other configurations depending on the shape and size of the slide lock, and thus of the corresponding sliding latch and guide support, for which it is intended. According to the present invention, the channel of the slider will have a configuration complementary to that of the sliding latch and the slider will have a configuration complementary to that of the aperture of the guide support onto which it is mounted, whatever the shape and size of the slide latch and guide support may be

The slider according to the preferred embodiment of the invention shown in the accompanying drawings is a slider 1 for use with a slide lock 3 of the type comprising a guide support 5 and a latch 7 slidably movable through apertures 9 of the guide support 5. The slider 1 comprises a main body 11 having opposite first and second surfaces 13, 16, and mounting means 17 provided on the first surface 13 of the main body 11 for removably mounting the slider 1 onto an aperture 9 of the guide support 5 of the slide lock 3. The slider 1 further comprises a channel 19 extending inside the main body 11 from the first surface 13 to the second surface 15 thereof. the channel 19 being shaped and sized to allow the latch 7 of the slide lock 3 to freely slide therethrough. The channel 19 is preferably further devised to reduce friction and vibrations of the latch 7 sliding through the channel 19 of the slider 1. Preferably also, the thickness of the main body 11, that is, the distance between the opposite first and second surfaces 13, 15, is devised so as to absorb the noise and vibrations caused by the impact from the end of travel of the sliding latch 7 against the guide support 5 of the slide lock 3.

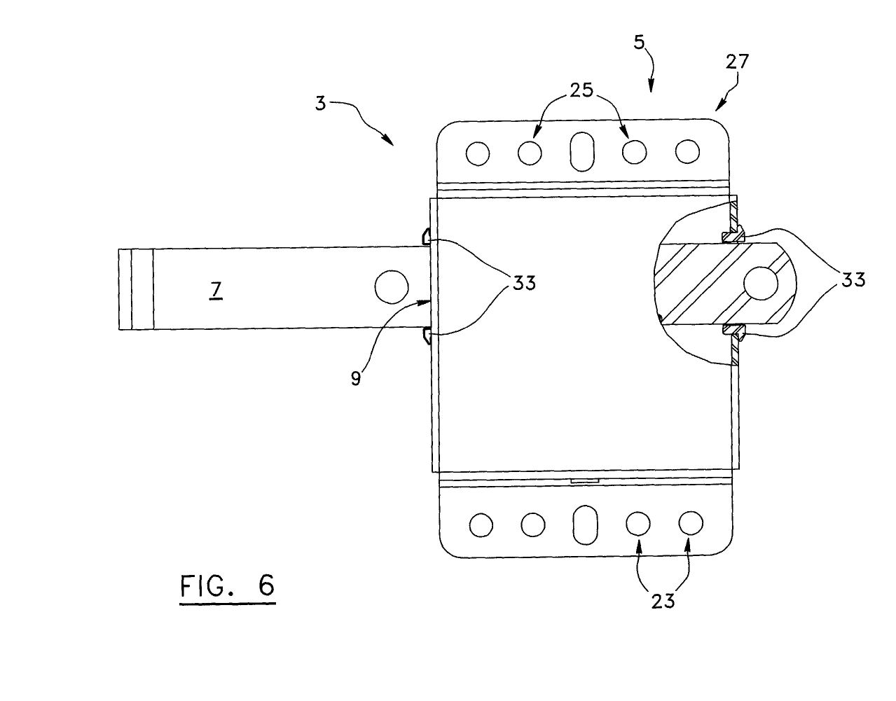

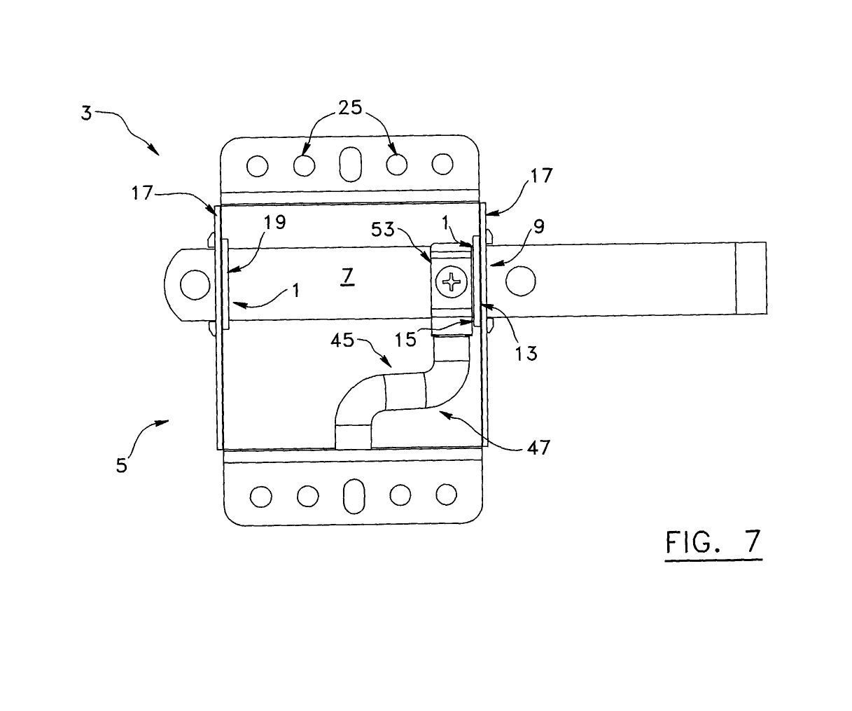

As it is very well known in the art, a slide look 3 is usually affixed onto a door 21, such as a garage door 21 for example, by means of fasteners 23 inserted into corresponding holes 25 provided along the peripheral edges 27 of the guide support 5 of the slide lock 3, as better shown in FIGS. 6 and 7. It is also known that the guide support 5 usually comprises two apertures 9 through which runs the sliding latch 7. Thus, according to the preferred embodiment of the invention, there is preferably one slider 1 associated with every aperture 9 of the guide support 5 of the slide lock 3.

Furthermore, it is also known in the art, as better shown in FIG. 7, that a slide lock 3 usually comprises a return mechanism 45 for its sliding latch 7, such as a spring 47 for example. As illustrated, the spring 47 usually has one end connected to the guide support 5 and another end affixed to the sliding latch 7 by means of a holder 53. This type of return mechanism 45 is usually devised to bias the movement of the sliding latch 7 and often causes the holder 53 of the latch 7 to strike the guide support 5, causing substantial noise and vibrations to the slide lock 3. Therefore, as mentioned hereinabove and as can be easily understood, the slider 1 according to the present invention is also devised to absorb the noise and vibrations caused by the impact from the end of travel of the sliding latch 7 hitting against the guide support 5 of the slide lock 3. The present invention may be used with slide locks 3 having other suitable return mechanisms 45, as apparent to a person skilled in the art.

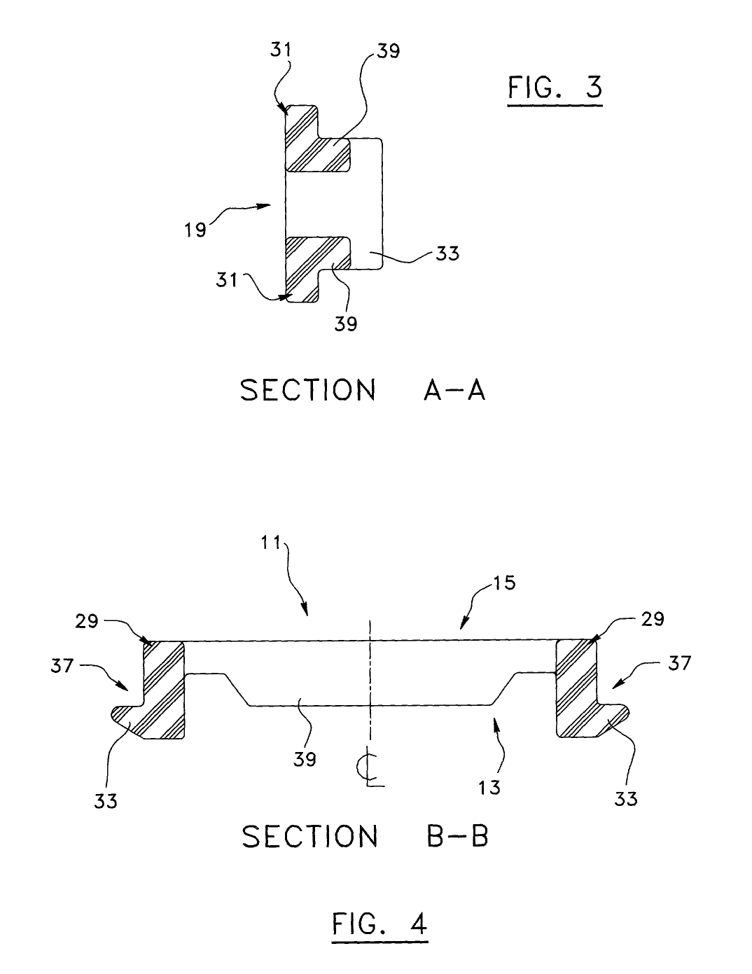

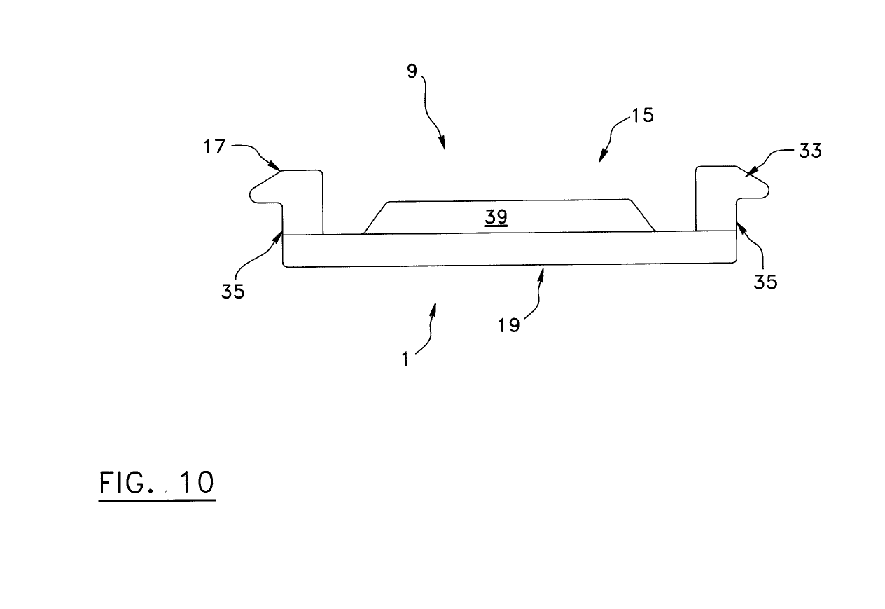

As better shown in FIGS. 1 to 4, the main body 11 preferably has a rectangular configuration with two opposite lateral sides 29 and two opposite longitudinal sides 31. The mounting means 17 preferably comprise a pair of hook-shaped flanges 33 provided respectively along each longitudinal side 31. Preferably also, the hook-shaped flanges 33 project from the first surface 13 of the main body 11 and are devised to be hooked onto opposite peripheral edges 35 of the aperture 9 of the slide lock 3, as better shown in FIGS. 7 to 10. According to the preferred embodiment of the invention, the hook-shaped flanges 33 are made of a suitable resilient and flexible maternal such that when the slider 1 is to be fitted onto the corresponding aperture 9, these hook-shaped flanges 33 are flexed inwardly toward the channel 19. Thereafter, the flanges 33 are inserted into the aperture 9 of the guide support 5, after which the hook-shaped flanges 33 are allowed to flex back outwardly, thereby holding the slider 1 snugly in position onto the aperture 9 of the guide support 5. The hook-shaped flanges 33 are preferably made of a plastic material, such as nylon for example, but may also be made of any other suitable resilient and flexible material, as apparent to a person skilled in the art.

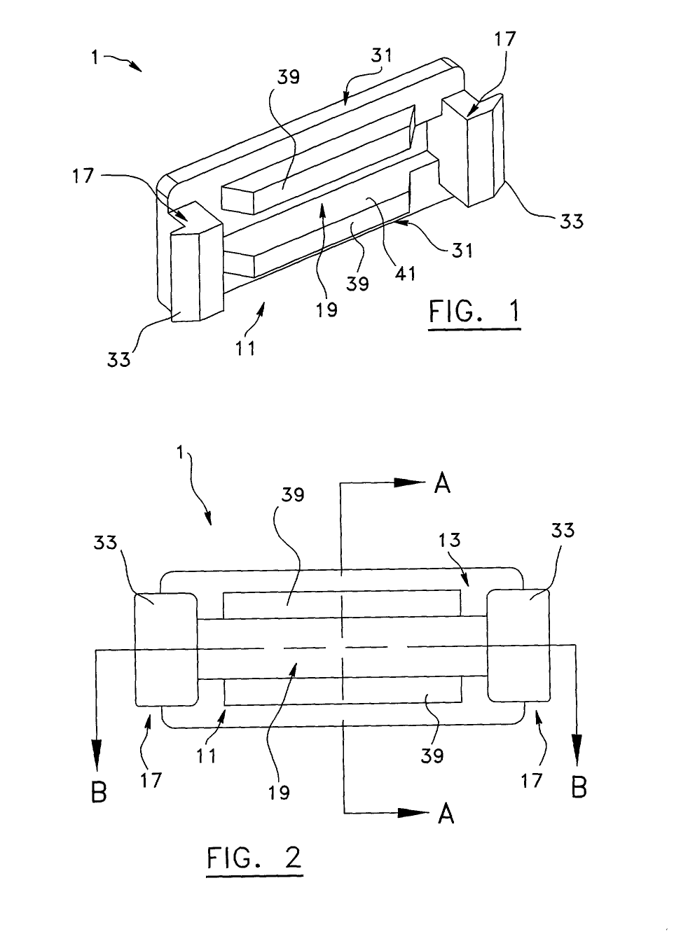

Although the above-described rectangular configuration of the main body 11 is not an essential feature of the present invention, it is considered to be advantageous since most of the slide locks 3 available in the trade have guide support apertures 9 of rectangular cross-section with corresponding sliding latches 7 of rectangular cross-section also. Consequently, the cross-section of the channel 19, as shown in FIGS. 1 and 2, is also preferably of rectangular configuration. As can be easily understood, the expression “rectangular” configuration is meant to also include the “square” configuration, which is also common to most cross-sections of sliding latches 7 and corresponding guide support apertures 9 of the slide locks 3 available in the trade. Furthermore, as explained hereinabove, the present invention is not limited to the above-described rectangular configuration and may take on various other configurations depending on the shape and size of the slide lock 3, and thus of the corresponding sliding latch 7 and guide support 5, for which it is intended.

Moreover, although the hook-shaped flanges 33 are a preferred embodiment of the mounting means 17, it is worth mentioning that other suitable mounting means 17, as apparent to a person skilled in the art, may be used with the present invention. For example, the mounting means 17 may consist of a pair of straight flanges 33 provided respectively along each longitudinal side 31, each flange 33 projecting from the first surface 13 of the main body 11 and being provided with a transversal groove (not shown) on an outermost face 37 of the flange 33, the respective grooves of the flanges 33 being devised to match and be hooked against the opposite peripheral edges 35 of the aperture 9 of the slide lock 3. Furthermore, although the mounting means 17 according to the preferred embodiment of the invention are devised to removably mount the slider 1 onto the aperture 9 of the guide support 5, suitable mounting means 17 for permanently mounting the slider 1 onto the guide support 5 also fall within the scope of the present invention, as apparent to a person skilled in the art. For example, the slider 1 may be molded upon the aperture 9 of the guide support 5 so as to be permanently mounted onto the slide lock 3.

As better shown in FIGS. 1 to 4, the slider 1 preferably further comprises a pair of shoulders 39 projecting from the first surface 13 of the main body 11 along the longitudinal sides 31 thereof. The shoulders 39 are preferably used to guide the latch 7 sliding through the channel 19 of the slider 1.

Although the above-described shoulders 39 are not an essential feature of the present invention, they are considered to be advantageous since the shoulders 39 help guide (i.e. align) the sliding movement of the latch 7 through the channel 19 of the slider 1, thereby providing the slider 1 with greater stability and thus improving performance thereof. As also apparent to a person skilled in the art, other suitable means may be used to fulfill the functions of the shoulders 39.

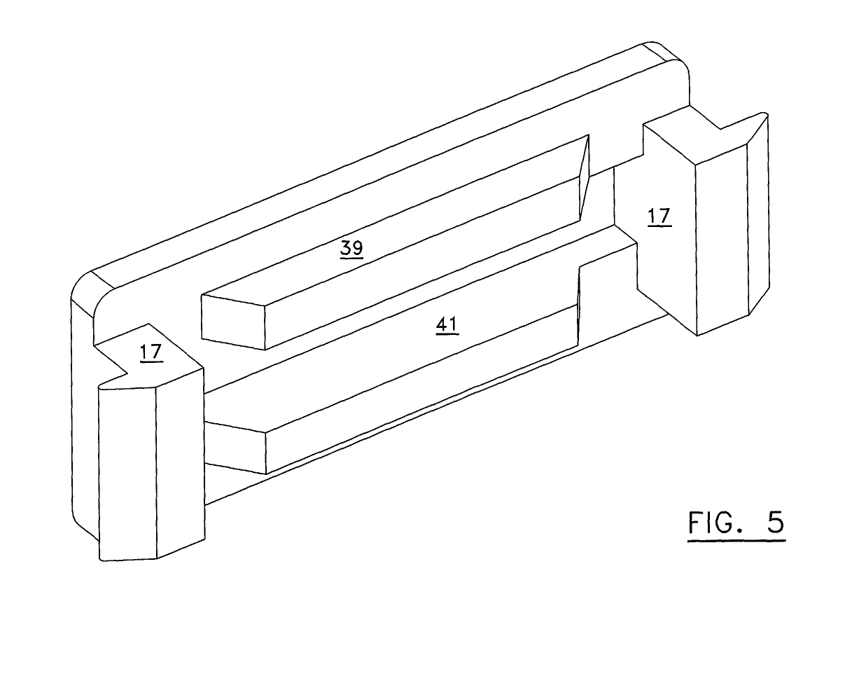

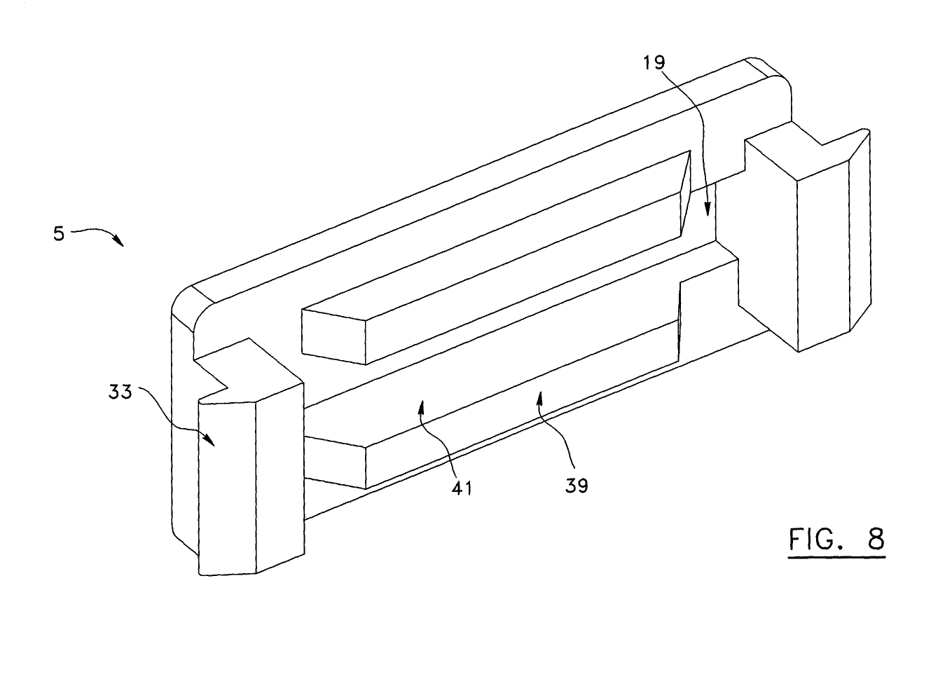

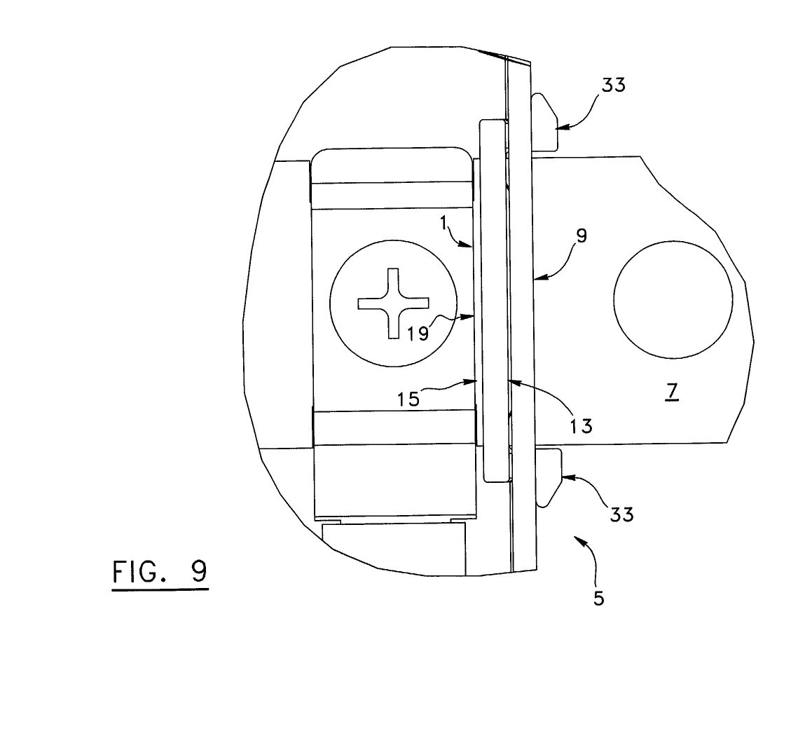

As better shown in FIGS. 5 and 8, the channel 19 is preferably provided with a lining 41 devised to reduce friction and vibrations of the latch 7 sliding through the channel 19. Preferably also, the slider 1 is made of plastic and the lining 41 of the channel 19 is made of nylon. Other suitable materials, preferably of adequate flexibility and compressibility, may be used for the slider 1 and/or the components thereof. depending on the particular applications for which they are intended, as apparent to a person skilled in the art. For example, polymers, ceramics, composites, ductile metallic alloys, organic materials, etc. may be used.

It is worth mentioning here that although the channel 19 (or main body 11 of the slider 1 for that matter) and lining 41 have been described herein as two distinct components, it is to be understood, as apparent to a person skilled in the art, that the channel 19 and lining 41 may be made integral to one another, that is, they may be made of one single piece, in which case they are preferably made of an unique and adequate material used to reduce the friction and vibrations of the latch 7 sliding through the channel 19. The same is true for the other components of the present invention. For example, the mounting means 17 can be made integral to the main body 11 of the slider 1 or may be removably affixed thereto. According to the preferred embodiment of the invention, the entire slider 1 is preferably moulded in a single step with a suitable polymer, thereby enabling reduced manufacturing costs for the slider 1.

According to the present invention and as better shown in FIGS. 6 to 10, there is also provided a slide lock 3 of the type comprising a guide support 5 and a latch 7 slidably movable through apertures 9 of the guide support 5, the slide lock 3 further comprising a slider 1 such as described hereinabove. The slider 1 of the slide lock 3 comprises a main body 11 having opposite first and second surfaces 13, 15, and mounting means 17 provided on the first surface 13 of the main body 11 for removably mounting the slider 1 onto an aperture 9 of the guide support 5 of the slide lock 3. The slider 1 of the slide lock 3 further comprises a channel 19 extending inside the main body 11 from the first surface 13 to the second surface 15 thereof, the channel 19 being shaped and sized to allow the latch 7 of the slide lock 3 to freely slide therethrough. The channel 19 is preferably further devised to reduce friction and vibrations of the latch 7 sliding through the channel 19 of the slider 1 of the slide lock 3.

The present invention is an improvement and presents several advantages over what is known in the prior art, in that, as explained hereinabove, the slider 1 used in conjunction with the slide lock 3 enables to reduce the noise, friction, and vibrations between the latch 7 and the guide support 5 of the slide lock 3. Indeed, the present invention enables to improve usage of slide locks 3 in that, by supporting and guiding the sliding latch 7 through the channel 19, preferably made of a non-abrasive and damping material, the slider 1 enables to reduce the noise, friction forces and vibrations which would be normally created by the sliding contact of the latch 7 moving against the apertures 9 of the guide support 5.

Furthermore, the present invention is advantageous in that the inside surface of the channel 19 is devised to facilitate the travel of the sliding latch 7 by having a preferably smooth, flat, and frictionness surface, and by also isolating the guide support 5 from the noises and vibrations caused by the latch 7 sliding therethrough. Moreover, as illustrated and explained herein, the present invention is also an improvement in that the thickness of the main body 11 of the slider 1 is shaped and sized so as to absorb the noise and vibrations caused by the impact from the end travel of the sliding latch 7 against the guide support 5 of the slide lock 3.

As may now be appreciated the present invention is also very advantageous in that the above-mentioned features of the slider 1, as explained in greater detail hereinabove, enable to substantially prolong the service life of the slide lock 3.

Moreover, it is worth mentioning that the present invention may be altered for the particular mounting situations required for a given slide lock 3. For example, should one not be able to remove the sliding latch 7 from the guide support 5 in order to mount the slider 1 thereon, it can be easily understood that the slider 1 may be provided with a slit (not shown) extending from an appropriate peripheral side 29, 31 of the main body 11 to the inside of the channel 19, said slit being devised so as to allow the slider 1 to be “split apart” and be coaxially mounted about the sliding latch 7, after which it can be slid along the latter and be pushed into or “snapped onto” the corresponding aperture 9 so that appropriately devised mounting means 17 can secure the slider 1 thereon, as apparent to a person skilled in the art.

Of course, numerous other modifications could be made to the above-described embodiments without departing the scope of the invention as defined in the appended claims.

1. A slider for use with a slide lock of the type comprising a guide support and a latch slidably movable through apertures of the guide support, said slider comprising:
a main body having opposite first and second surfaces; and
mounting means provided on the first surface of the main body for removably mounting the slider onto an aperture of the guide support of the slide lock;
wherein the slider further comprises a channel extending inside the main body from the first surface to the second surface thereof, said channel being shaped and sized to allow the latch of the slide lock to freely slide therethrough.

2. A slider according to claim 1, wherein the main body has a rectangular configuration with two opposite lateral sides and two opposite longitudinal sides, and wherein the mounting means comprise a pair of hook-shaped flanges provided respectively along each longitudinal side, said hook-shaped flanges projecting from the first surface of the main body and devised to be hooked onto opposite peripheral edges of said aperture.

3. A slider according to claim 2, wherein said slider further comprises a pair of shoulders projecting from the first surface of the main body along the longitudinal sides thereof, said shoulders being used to guide the latch sliding through the channel of the slider.

4. A slider according to claim 1, wherein the channel is provided with a lining devised to reduce friction and vibrations of the latch sliding through the channel.

5. A slider according to claim 4, wherein the slider is made of plastic and the lining of the channel is made of nylon.

6. A slider for use with a slide lock of the type comprising a guide support and a latch slidably movable through apertures of the guide support, said slider comprising:
a main body having opposite first and second surfaces; and
mounting means provided on the first surface of the main body for removably mounting the slider onto an aperture of the guide support of the slide lock;
wherein the slider further comprises a channel extending inside the main body from the first surface to the second surface thereof, said channel being shaped and sized to allow the latch of the slide lock to freely slide therethrough, said channel being further devised to reduce friction and vibrations of the latch sliding therethrough.

7. A slider for use with a slide lock of the type comprising a guide support and a latch slidably movable through apertures of the guide support, said slider comprising:
main body having opposite first and second surfaces; and
mounting means provided on the first surface of the main body for removably mounting the slider onto an aperture of the guide support of the slide lock;
wherein the slider further comprises a channel extending inside the main body from the first surface to the second surface thereof, said channel being shaped and sized to allow the latch of the slide lock to freely slide therethrough, and wherein the distance between the opposite first and second surfaces is devised so as to absorb noise and vibrations caused by an impact from an end of travel of the sliding latch hitting against the guide support of the slide lock.

8. A slide lock of the type comprising a guide support and a latch slidably movable through apertures of the guide support, said slide lock further comprising a slider, said slider comprising:
a main body having opposite first and second surfaces; and
mounting means provided on the first surface of the main body for removably mounting the slider onto an aperture of the guide support of the slide lock;
wherein the slider further comprises a channel extending inside the main body from the first surface to the second surface thereof, said channel being shaped and sized to allow the latch of the slide lock to freely slide therethrough, said channel being further devised to reduce friction and vibrations of the latch sliding therethrough.

9. A slide lock according to claim 8, wherein the main body of the slider has a rectangular configuration with two opposite lateral sides and two opposite longitudinal sides, and wherein the mounting means of the slider comprise a pair of hook-shaped flanges provided respectively along each longitudinal side, said hook-shaped flanges projecting from the first surface of the main body and devised to be hooked onto opposite peripheral edges of said aperture.

10. A slide lock according to claim 9, wherein said slider further comprises a pair of shoulders projecting from the first surface of the main body along the longitudinal sides thereof, said shoulders being used to guide the latch sliding through the channel of the slider.

11. A slide lock according to claim 8, wherein the channel is provided with a lining for reducing the friction and vibrations of the latch sliding through the channel.

12. A slide lock according to claim 11, wherein the slider is made of plastic and the lining of the channel is made of nylon.
